(19) United States
(12) Patent Application Publication
(10) Pub. No.: US 2023/0419244 A1
(43) Pub. Date: Dec. 28, 2023

(54) USING DATA ANALYTICS TO OPTIMIZE LOGISTICS WITHIN PRODUCT DISTRIBUTION NETWORK

(71) Applicant: International Business Machines Corporation, Armonk, NY (US)

(72) Inventors: Siddhartha Sood, Ghaziabad (IN); Sandip Goswami, Kolkata (IN); Rahul Roy, Kolkata (IN); Biswanath Mukherjee, Kolkata (IN); Jaydeep Sarkar, Kolkata (IN)

(21) Appl. No.: 17/809,305

(22) Filed: Jun. 28, 2022

(51) Int. Cl. G06Q 10/08; G06Q 30/06

(52) U.S. Cl. CPC G06Q 10/08355; G06Q 30/0635

(57) ABSTRACT

Logistics are optimized for delivering a product within a product distribution network. A computer receives order data, the order data includes order information and a delivery location of a product ordered by a user. The order data further includes an order history of the user including order returns or cancelations. Using data analytics, the order data is analyzed to determine a logistics plan for the delivery of the product. A probability of return of the product is calculated, and a probability of re-order of the product is calculated. As part of the logistics plan and based on the analyzing of the order data, a recommended storage facility is generated for a second delivery location resulting from a re-routing of the delivery of the product, in response to the order being canceled.

### BACKGROUND

The present disclosure relates to using data analytics for optimizing logistics for product delivery within a product distribution network.

In one example, a manufacturer's product can move through a supply chain network to reach the distributor or customer. A process or management of the product logistics after the delivery of the product involves reverse logistics. If the product is returned by a customer, a manufacturing firm or retailer can organize return shipping of the product, wherein the returning product can travel in reverse through the supply chain network using reverse logistics.

In another example, for parcel deliveries there can be a case where the end customer refuses to collect the products due to delay in shipment or order duplication or a wrong shipment. In such cases, there is no damage notified/reported with the cargo and it is still in packed conditions. The reverse logistics of carrying the package back to the seller can be an expensive process as the package is sent back via the shipper which incurs the expense of shipping and shipping impact on the environment, such as transport exhaust and fuel.

### SUMMARY

The present disclosure recognizes the shortcomings and problems associated with current techniques for optimizing logistics for product delivery within a product distribution network.

The present invention can include using data analytics for optimizing logistics for product delivery within a product distribution network including when a product delivery is canceled, and which can also include a product being rerouted to another delivery node.

Embodiments of the present invention can improve return logistics including return costs and environmental impact. Methods and systems according to the present invention can allow a carrier or third party logistics company to preserve the product for a predefined period of time at the carrier to facilitate redelivery to another customer for any cross-sale opportunity for the seller within proximity of that location. This helps maximizing ecosystem benefits and can be more sustainable logistically, as an alternative to sending the product back to the shipper which is both expensive and adverse for environment. Return logistics according to embodiments of the present invention can include multiple parties and multiple decisions made which can result in benefits for both shippers and carriers.

In an aspect according to the present invention, a computer-implemented method for optimizing logistics for delivering a product within a product distribution network includes receiving, at a computer, order data. The order data includes order information and delivery location of a product ordered by a user. The order data further including an order history of the user including order returns or cancelations, and the order data further including a start location for the product, and a route for delivery of the product to the delivery location. The method includes, using data analytics, for analyzing the order data to determine a logistics plan for the delivery of the product. The analyzing including calculating a probability of return of the product, a probability of re-order of the product, and storage facility locations in relation to the route; and generating, as part of the logistics plan and based on the analyzing of the order data, a recommended storage facility for a second delivery location resulting from a re-routing of the delivery of the product, in response to the order being canceled and the product being in transit to the delivery location.

In a related aspect, the recommended storage facility is a warehouse in a vicinity of the product when the product is in transit to the delivery location.

In a related aspect, the recommended storage facility is an originating warehouse for the product.

In a related aspect, the user is a consumer.

In a related aspect, the user is a distributor for the product.

In a related aspect, the method can include calculating a time duration for the product to remain at the recommended storage facility.

In a related aspect, the method further includes calculating a time duration for the product to remain at the recommended storage facility; and initiating shipping of the product to another storage facility when the duration of time has lapsed.

In a related aspect, the method further includes calculating when the product has a higher likelihood of reorder when the product is moved to another storage facility.

In a related aspect, the probability of the re-order of the product includes determining a popularity of the product among customers.

In a related aspect, the method further includes updating a computer model of the logistic plan, using the computer; wherein the updated model includes the following; updating the received order data; updating the analyzing of the order data, including updating of the calculating of the probability of a return of the product and the probability of the re-order of the product; and generating an updated recommended storage facility.

In a related aspect, the method further includes iteratively generating the model to produce updated models.

In a related aspect, the method further includes communicating, using the computer, the recommended storage facility to a control system; and communicating the re-routing of the delivery of the product to the control system; and physically transporting the product to the recommended storage facility using the control system.

In a related aspect, the routing of the product includes a transport vehicle.

In another aspect according to the present invention. a system for optimizing logistics for delivering a product within a product distribution network includes a computer system. The computer includes; a computer processor, a computer-readable storage medium, and program instructions stored on the computer-readable storage medium being executable by the processor, to cause the computer system to perform the following functions to; receive, at a computer, order data, the order data including order information and delivery location of a product ordered by a user, the order data further including an order history of the user including order returns or cancelations, the order data further including a start location for the product, and a route for delivery of the product to the delivery location; using data analytics, analyze the order data to determine a logistics plan for the delivery of the product; the analyze including calculating a probability of return of the product, a probability of re-order of the product, and storage facility locations in relation to the route; and generate, as part of the logistics plan and based on the analyzing of the order data, a recommended storage facility for a second delivery location resulting from a re-routing of the delivery of the product, in response to the order being canceled and the product being in transit to the delivery location.

In a related aspect, the recommended storage facility is a warehouse in a vicinity of the product when the product is in transit to the delivery location.

In a related aspect, the recommended storage facility is an originating warehouse for the product.

In a related aspect, the user is a consumer.

In a related aspect, the user is a distributor for the product.

In a related aspect, further including calculating a time duration for the product to remain at the recommended storage facility.

In another aspect according to the present invention, a computer program product for optimizing logistics for delivering a product within a product distribution network includes a computer readable storage medium having program instructions embodied therewith. The program instructions are executable by a computer to cause the computer to perform functions, by the computer, comprising the functions to; receive, at a computer, order data, the order data including order information and delivery location of a product ordered by a user, the order data further including an order history of the user including order returns or cancelations, the order data further including a start location for the product, and a route for delivery of the product to the delivery location; using data analytics, analyze the order data to determine a logistics plan for the delivery of the product; the analyze including calculating a probability of return of the product, a probability of re-order of the product, and storage facility locations in relation to the route; and generate, as part of the logistics plan and based on the analyzing of the order data, a recommended storage facility for a second delivery location resulting from a re-routing of the delivery of the product, in response to the order being canceled and the product being in transit to the delivery location.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1A is a flow chart illustrating a method, using one or more systems shown in the figures, for delivering a product within a product distribution network.

FIG. 1B is flow chart, continuing from the flow chart shown in FIG. 1A.

FIG. 1C is a flow chart, continuing from the flow chart shown in FIG. 1B.

FIG. 2A is a functional schematic block diagram showing a series of operations and functional methodologies, for instructional purposes illustrating functional features of the present disclosure associated with the embodiments shown in the FIGS., for optimizing logistics for delivering a product within a product distribution network.

FIG. 2B is a functional schematic block diagram continuing from FIG. 2A.

FIG. 3 is a functional block diagram illustrating another system according to an embodiment of the present invention, for optimizing logistics for delivering a product within a product distribution network.

FIG. 4 is a flow chart depicting a method according to another embodiment of the invention, and in coordination with the systems shown in the figures.

FIG. 5 is a flow chart depicting another method according to the present disclosure, continuing from the method shown in FIG. 4.

FIG. 6 is a schematic block diagram depicting a computer system according to an embodiment of the disclosure which may be incorporated, all or in part, in one or more computers or devices shown in FIG. 1, and cooperates with the systems and methods shown in the FIGS.

FIG. 7 is a schematic block diagram of a system depicting system components interconnected using a bus. The components for use, in all or in part, with the embodiments of the present disclosure, in accordance with one or more embodiments of the present disclosure.

FIG. 8 is a block diagram depicting a cloud computing environment according to an embodiment of the present invention.

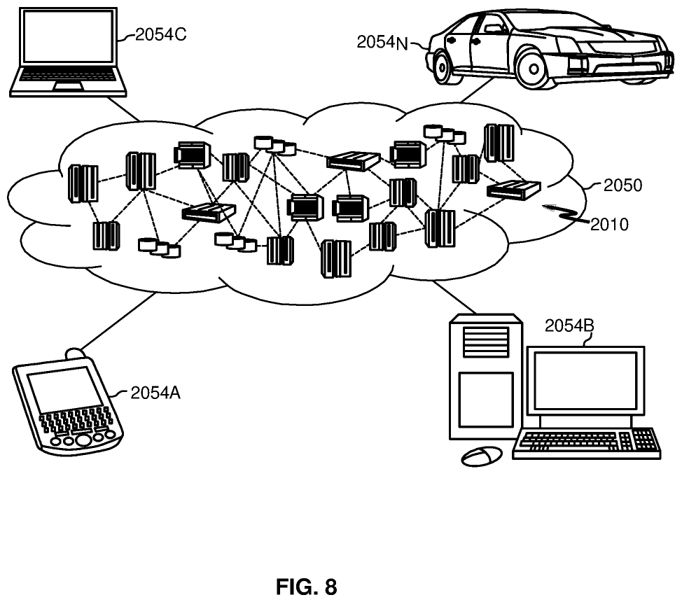

FIG. 9 is a block diagram depicting abstraction model layers according to an embodiment of the present invention.

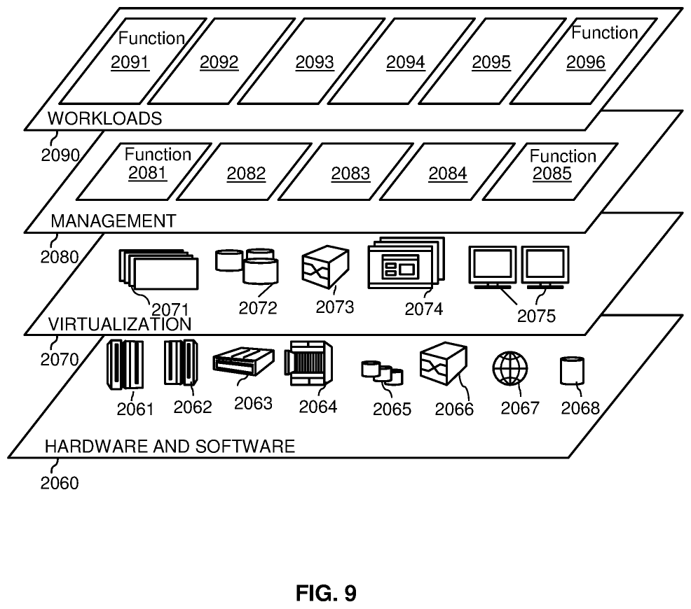

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### EMBODIMENTS AND EXAMPLES

Embodiments of the present disclosure can leverage machine learning to predict answer questions that help both a shipper and carrier to decide if and when a product can be preserved by the carrier and leveraged for a cross selling opportunity. One question includes a probability of return and how likely it is that a product will be returned by a customer. Such a determination can be made from a carrier perspective who may deliver multiple products to the same customer. Another question includes a probability of reorder and how likely is that a product will be reordered in a near future anywhere else on a carrier's supported network, i.e., should the product be stored by the carrier or returned to the shipper. Another question includes a location for product warehousing and what is the most suitable location where the carrier should warehouse the product. There can be several options, for example, such as a city warehouse, a district hub, a regional hub or a central country hub. Each of these locations has an associated cost for the carrier and hence has to be selected considering how soon the product can be redelivered to another customer from these locations. Another question includes duration of storage and how long the carrier should store the product. Storage is a cost for the carrier, and thus, for example, fast-moving products would be stored for less time and hence can be better suited for preservation versus slow moving products.

For a large 3rd party or 4th party logistics provider who owns large network of locations (e.g., hubs that could be regional/district or central, or country wide, and further package sorting facilities, delivery centers, pickup locations), typical data that is owned can include shipment flow movement, network data, consignee data among others. In many scenarios, these 3PL (third party logistics companies) and 4PL (fourth party logistics companies) can also own their own warehouses that serve as short term storage facilities. The data in itself may not be enough when it comes to solving the problem of reverse logistics by a 3PL/4PL provider. Embodiments of the present disclosure can include recommending mashing up data from 3PL, shippers, retailers, warehouse providers in order to leverage advanced analytics and machine learning to build key insights that can be leveraged during returns process to help maximize benefits for all parties along with keeping sustainable thresholds for the environment.

An overview of a system using data that can be leveraged by a reverse logistics system. The reverse logistics system can receive product information and information regarding an originating warehouse which can be a 3PL. The reverse logistics system can receive product and delivery geographic location from a retailer initiated by a user, and product and delivery geographic location information from a shipper. The system can notify the 3PL of an identified warehouse based on an algorithm. The system can notify the retailer of an identified new warehouse based on the algorithm, and notify the shipper of the identified new warehouse based on the algorithm.

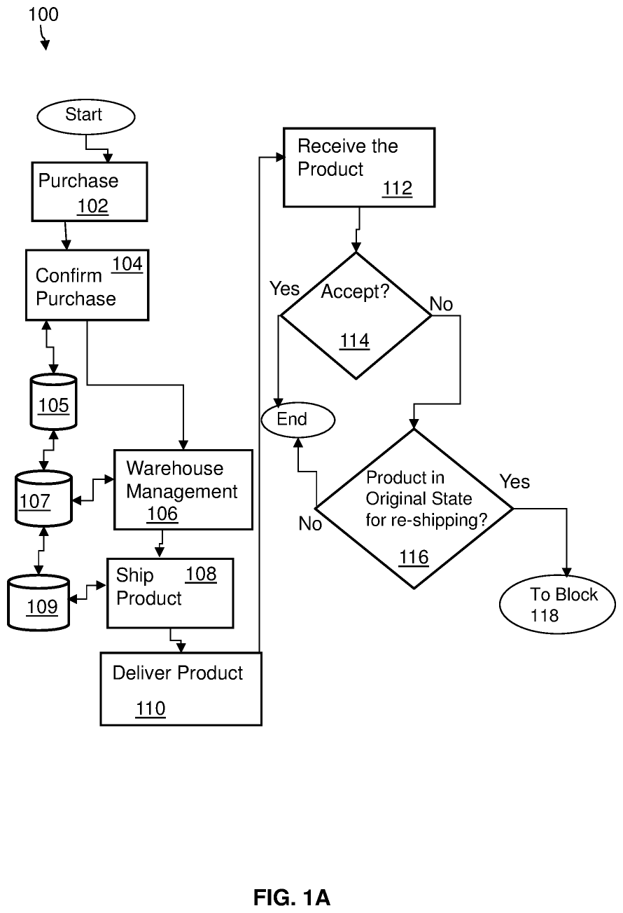

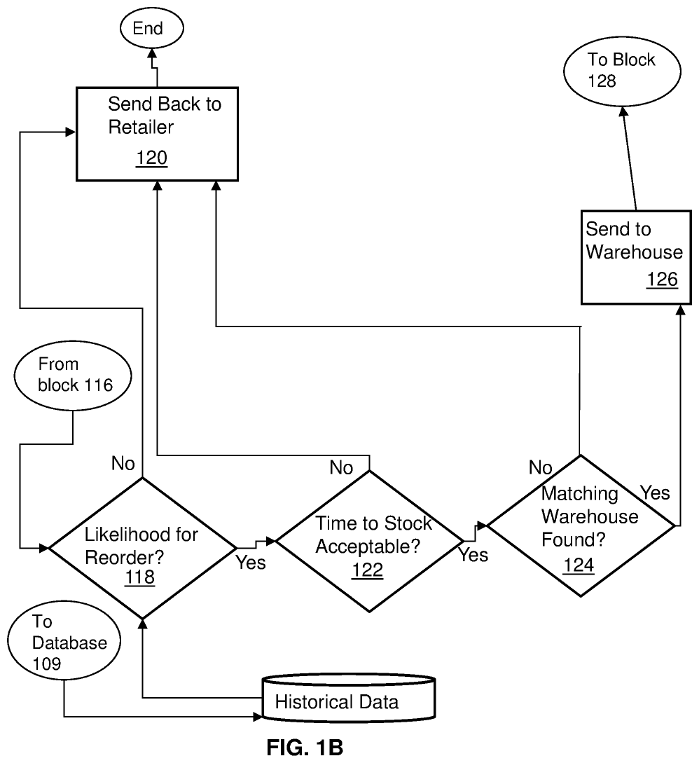

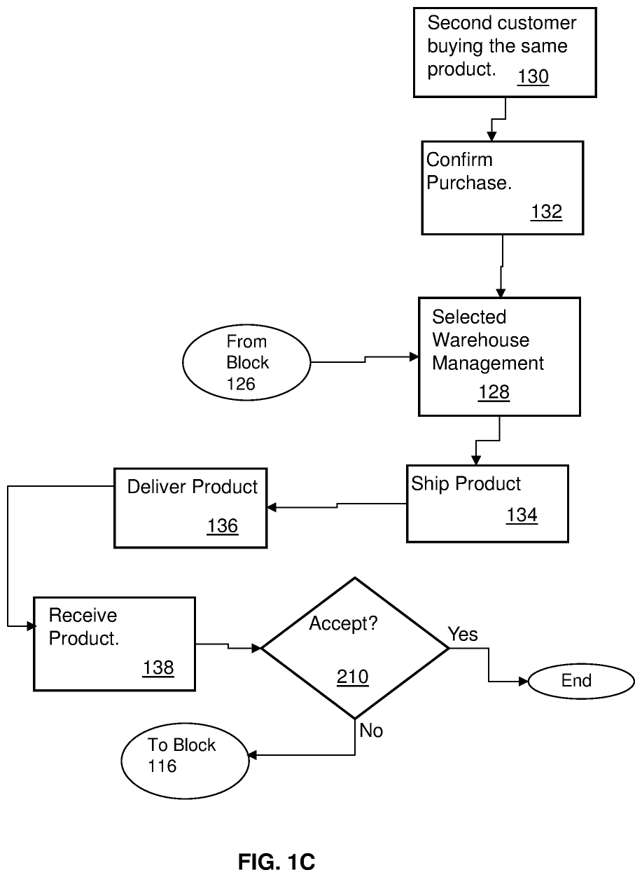

Referring to FIG. 1A, in one embodiment according to the present disclosure, a system depicts a process of the shipping and returns involving multiple actors and systems. The system 100 can also be characterized as a process or a method. The system 100 includes enabling dynamic warehouse selection based on probability of reorder and other characteristics. The methods and systems according to the present disclosure enables shippers, retailers, and warehouse providers to exchange data that will allow them to pick the right warehouse where returns can be stored so that they can be leveraged for reorder opportunities by a 3PL. The process shown in FIG. 1 depicts multiple scenarios.

Referring to FIG. 1A, and end user or customer can make a purchase 102. The process 100 can confirm the purchase 104. Data regarding the purchase can be stored by the retailer at a database 105. Warehouse management 106 can be implemented by a 3PL and a warehouse database 107 can store data. The product is shipped 108 by a shipper. The shipper also can store shipping data in a database 109. A carrier delivers the product, as in block 110.

The end user can receive the product, as in block 112. The end user can determine whether to accept the product or return it, at block 114. When the product is accepted, the system process ends. When a return is initiated by the end user, the system can inform the shipper of the return status, and the shipper can determine whether the product is in the same original state for re-shipping, as in block 114. The system includes determining if the product is in its original state for re-shipping, in block 116. When it is not, the process ends. When the product is in its original state, the system proceeds to block 118.

Referring to FIG. 1B, the system includes determining a likelihood or reorder of the product returned, or when there is a high likelihood of return of the product, as in block 118. If the likelihood of a reorder is low or none, the system can proceed to send the product back to the retailer at block 120 and end the process. If the likelihood of a reorder is high or certain or already available, the system can proceed block 122 to consider how long to stock the product, that is, is the time to stock the product acceptable. If the time is not acceptable, the system can proceed to block 120. If the time is acceptable, the system can proceed to determine if a matching warehouse for storage is found, at block 124. If a matching warehouse is not found, the system can proceed to block 120. If a matching warehouse is found, the system can continue to send the product to a selected warehouse, at block 126. The selected warehouse can be for example, local, regional or a central warehouse.

Referring to FIG. 1C, the system 100 continues to block 128 for warehouse management of the selected warehouse. A second customer can buy the same product, as in block 130. The purchase is confirmed at block 132. The system ships the product from the selected warehouse, as in block 134, and the product is delivered to the second customer at block 136, and the product is received by the second customer at block 138. When the second customer accepts the product, the process ends. When the second customer does not accept the product at block 210, the system returns to block 116.

In general, according to embodiment of the present disclosure, in one scenario, a product may be returned but has high demand and was placed at a first warehouse or a second warehouse. Such placement can depend on factors such as likelihood of reorder and warehouse selection based on a location prediction for the product. Along with warehouse, the duration of storage is also leveraged to ensure high moving products always get priority. In another scenario, a product may be returned but does not have high demand in locations supported by a first warehouse or a second warehouse. The product may be moved to a central warehouse from where it can be routed to any location where demand comes from. Along with a warehouse, the duration of storage is also leveraged to ensure high moving products always get priority. In another scenario, a product may be returned and does not have enough demand associated with the product, and hence the product can be retuned back to the shipper.

Systems and methods according to embodiments of the present disclosure provide the ability to leverage internal & partner data ecosystem (between shippers/retails, 3PL providers and warehouse providers) to predict the likelihood of product returns and use those insights to drive decisions around warehouse product placements and warehouse inventory levels. Further, a system and method may provide the ability to leverage internal & partner data ecosystem (between shippers/retails, 3PL providers) to predict the likelihood of product reorder once a product is returned. Additionally, a method and system can provide the ability to leverage internal & partner data ecosystem (between shippers/retails, 3PL providers and warehouse providers) to predict the set of possible locations from where product reorder will happen. Further, a method and system can provide the ability to leverage internal & partner data ecosystem (between 3PL providers and warehouse providers) to determine the best warehouse location to store the shipment considering factors such as reorder likelihood and reorder duration. Moreover, a method and system can provide the ability to leverage internal & partner data ecosystem (between 3PL providers and warehouse providers) to determine the duration for which the product should be stored at the warehouse. Additionally, a method and system can provide the ability to determine the subsequent action on the shipment in warehouse once the product has passed it storage duration date within the warehouse. These could range from returning the product back to shipper, moving the product to a different warehouse, or continue storing the product for an extended duration within the same warehouse. Further, a method and system can provide the ability to leverage likelihood of returns to determine product differences for higher moving product reorders versus lower moving product reorders allowing further decisions on managing warehouse inventory levels, and the ability to consider feedback loop for each of the recommendation and improve the decision-making process for subsequent iterations continuously. Systems and methods according to the present disclosure, can lay a foundation for data sharing based ecosystem benefits between multiple partners allowing rich benefits around cost savings, sustainability and revenue generation.

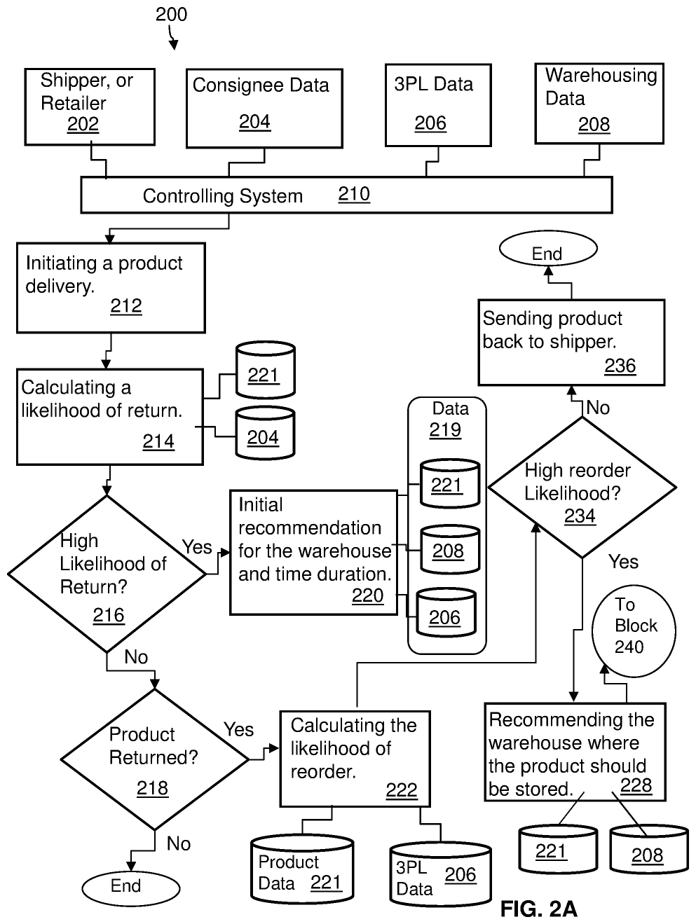

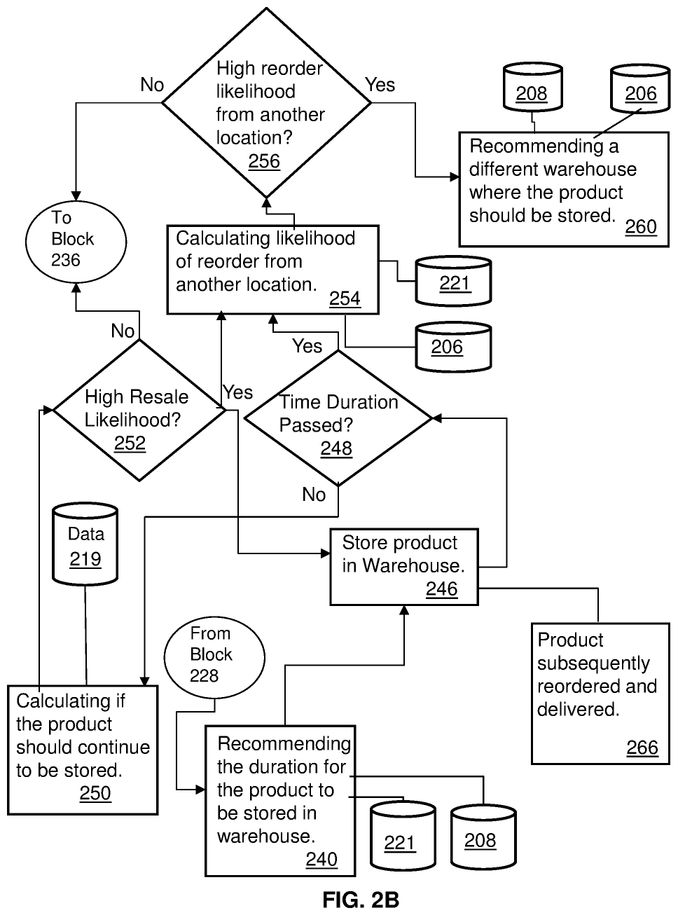

Referring to FIG. 2, according to the present disclosure, a process 200 includes a controlling system 210 including operational blocks that depict an embodiment which can also answer questions including: what is the likelihood of a particular shipment to be returned; What is the likelihood of a particular shipment to be reordered; what are top locations that are supported from which the shipment can be re-ordered; how long should a product be stored at a warehouse; does the product need to be sent back to the shipper after a certain duration of time to make way for high moving products; and does the product need to be moved to another location?

Again, referring to FIG. 2, the process 200 includes a shipper or retailer and product data 202. The shipper and product data can include product demand, product details, shipper details, historical returns, origin details, historical reorder, and product to area/location affinity. The process 200 includes consignee data 204 from a shipper. The data can include returns history, and destination details. The process can include 3PL data 206. The data can include historical return data for the product, historical return data for the consignee, and the transit network data. The process can include a warehouse data 208. The warehouse data can include order timeliness by product, order by destination, current inventory levels, and current storage availability. The system communicates with the shipper 202, and can receive consignee data 204 and 3PL data 206, and can communicate with the warehouse 208.

The process 200 includes the controlling system 210 initiating operational steps which includes initiating a product delivery as in block 212. For example, a shipment delivery can be initiated when a shipper places as order with a logistics provider. As part of this delivery, the logistics provider can leverage its resources to determine the best route that the shipment needs to take for the package to reach its destination.

The process 200 includes calculating the likelihood of a return of a shipped product, as in block 214. The system 210 can include leveraging product historical returns data from a shipper and leveraging consignee historical data from a shipper. The system can also include leveraging product historical returns data from a 3PL, and leveraging consignee historical data from a 3PL. The system can calculate the probability/likelihood of return based on shipper historical data & consignee historical data. Multiple techniques to mix the dataset can be leveraged such as calculating the probability individually based on shipper data or consignee data or calculating it on the whole data set. The system can also leverage multiple techniques such as advanced analytics, rules-based engine, or machine learning models to calculate this probability. Examples of rule based approach could be decision logic on certain product bar codes versus other inventory systems using product or a shipper combination. An example of machine learning models could be logistics regression models. The system can consider or factor in the actual outcome to improve the prediction approach through a feedback loop. The process includes determining when there is a high likelihood of return for the product, as in block 216. A likelihood check can be based on a dynamic threshold value/score. When there is not a high likelihood of return the process proceeds to block 218 to determine if the product has been returned. If the product has not been returned, the process ends. If the product has been returned, the process proceeds to block 222 to calculate the likelihood of a reorder. When there is a high likelihood of return, the process proceeds to block 220. Calculating the likelihood of reorder can include using data such as product data 221 and 3PL data 223. Thus the system provides initial recommendation for potential warehouse and duration for which the product should be stored at the warehouse. The system leverages product data from shipper about orders that are already in the system for similar products or projected orders. The system can leverage 3PL data about shipments for similar products that are being moved to different destinations. The system leverages warehouse data to understand current inventories of those products at different warehouses. The recommendation can help build an initial decisioning that can be leveraged.

The process includes determining when the product is returned at block 218. The system can identify if the product was returned or a return was initiated by the customer. It can be ascertained that the product is qualified for 3PL to hold for redelivery. If the product was not returned, then the process ends.

When a high reorder likelihood is calculated, at block 234, the process proceeds to recommending the warehouse where the product should be stored, at block 228. When a high likelihood of reorder is not calculated, the process sends the product back to the shipper, at block 236, and the process ends.

Additionally, after a product is returned at block 218, the system calculates the likelihood of reorder, at block 222. The system can leverage product historical order data from the shipper. The system can also leverage product historical shipments from a 3PL. The system can calculate the probability/likelihood of reorder based on shipper historical data & 3PL historical data. Multiple techniques to mix the dataset can be leveraged to calculate the probability based on shipper data or 3PL data or calculating the probability based on the whole data set. The system can also leverage multiple techniques such as advanced analytics, rules-based engine, or machine learning models to calculate the probability. Examples of a rule-based approach could be decision logic on certain products versus others or by a product/shipper combination. Examples of machine learning models can also be used and use logistics regression models. The system can have the ability to consider/factor in the actual outcome (if a redelivery through a reorder came in later) to improve the prediction approach through a feedback loop. The system can recommend the warehouse where the product should be stored, and can leverage 3PL data for historic reorders from a particular warehouse. The system can leverage warehouse data for the current inventory levels of the product at a particular warehouse. The system can leverage outcomes to derive recommendations on the locations where possible reorders can happen, and the system can calculate warehouse recommendations from where reorders can be shipped based on available data. Multiple techniques to mix the dataset can be leveraged such as calculating the probability individually based on warehouse data or 3PL data or calculating it on the whole data set. The system can also leverage multiple techniques such as advanced analytics, rules-based engine, or machine learning models to calculate these recommendations. Examples of rule-based approach could be decision logic on certain products or by product/shipper combination. Examples of machine learning models could be logistics regression models. The system can have the ability to consider/factor in the actual outcome (if an order for the same product code came in from) to improve the prediction approach through a feedback loop.

Referring to FIGS. 2A and 2B, the process 200 includes recommending the duration for the product to be stored in a warehouse, in block 240. The product is stored in the warehouse at block 246. When a time duration has passed, at block 248, the system can calculate the likelihood of a reorder form another location, at block 254. When the time duration has not passed, at block 248, the system can calculate whether the product should continue to be stored at block 250. When the product has a high resale likelihood at block 252, the system can store the product in a warehouse. In another example, when there is a high resale likelihood the system can check for a new warehouse to send the product for storage based on its resale likelihood or reorder from another location, as in block 254. If there is a high reorder likelihood form another location at block 256, the system can recommend a different warehouse where the product can be stored at block 260. Once the product is stored in a warehouse at block 246, the product can subsequently be reorder and delivered, as in block 266.

In one example, the data available and stored from a shipper or retailer can include details about the shipper, product demand, product bar code details, historical return information and product location affinity and consignee purse and return history. In another example, a 3PL data can include historical return data for the product, and return data for the consignee. The 3Pl data can also include transit network data. In another example, warehouse data can include order timelines associated to products current inventory data and current storage availability.

Additionally, the system can recommend the duration for which the product should be stored at the warehouse waiting for a reorder, and the system can leverage product data for historic reorders from a particular warehouse. The system can leverage warehouse data for the current inventory levels of the product at a particular warehouse. The system can calculate a recommended duration for which the product will be stored at the warehouse. Multiple techniques can mix the dataset and can be leveraged such as calculating the recommendation individually based on warehouse data or product data or calculating it on the whole data set. The system can also leverage multiple techniques such as advanced analytics, rules-based engine, or machine learning models to calculate recommendations. Examples of a rule-based approach can include decision logic on products versus others or by product/shipper combination. In one example of machine learning, models can be linear regression models. The system can consider/factor in the actual outcome (actual duration for reorder at a warehouse) to improve the prediction approach through a feedback loop. The system can check if the duration has passed and the product is still within the warehouse, and a reorder has not taken place. The system can calculate if the product should continue to be stored or should be returned to the shipper. The system can leverage data and insights to validate if there is potential of new high moving products (high reorder potential) coming to a warehouse that would require slow moving (low reorder potential) products. The system can leverage product historical returns & reorder data from a shipper. The system can leverage 3PL historical information returns and reorder data. The system leverages order historical data from a warehouse. The system calculates the probability/likelihood of continuing storage based on shipper historical data, 3PL data and consignee historical data. Multiple techniques can be used to mix the dataset and can be leveraged, such as calculating the probability individually based on shipper data or 3 PL data or warehouse data or calculating it on the whole data set by mixing and matching. The system can also leverage multiple techniques such as advanced analytics, rules-based engine, or machine learning models to calculate this likelihood. For examples, a rule-based approach could be decision logic on certain products versus others or by product/shipper combination. In another example of machine learning models could be logistics regression models or linear regression models providing number of additional days for which the product should be further stored.

In other examples, the system can calculate the likelihood of reorder from another location. The system can leverage product historical order data from a shipper. The system can leverage product historical shipments from a 3PL. The system can eliminate all historical data that could point to a reorder from a location that is served by the warehouse where the product is currently stored. The system can calculate the probability/likelihood of reorder based on a shipper historical data and 3PL historical data. Multiple techniques can mix the dataset and can be leveraged such as calculating the probability individually based on shipper data or 3PL data or calculating it on the whole data set. The system can also leverage multiple techniques such as advanced analytics, rules-based engine, or machine learning models to calculate the probability. Examples of rule based approach can include decision logic on certain products versus others or by product/shipper combination. The system would have the ability to consider/factor in the actual outcome (if a redelivery through a reorder came in later) to improve the prediction approach through a feedback loop. The system checks if there is a higher likelihood of reorder from another location, and the system recommends a different warehouse where the product should be stored. The system can leverage 3PL data for historic reorders from a particular warehouse. The system leverages Warehouse data for the current inventory levels of the product at a particular warehouse. The system can eliminate all historical data that could point current warehouse where the product is currently stored. The system can leverage outcomes to derive recommendations on the locations where possible reorders can happen. The system can calculate warehouse recommendations from where reorder can be shipped based on available data. Multiple techniques to mix the dataset can be leveraged such as calculating the probability individually based on warehouse data or 3PL data or calculating it on the whole data set. The system can also leverage multiple techniques such as advanced analytics, rules-based engine, or machine learning models to calculate these recommendations. Examples of rule-based approach could be decision logic on certain products versus others or by product/shipper combination. The system can consider/factor in the actual outcome (if an order for the same product code came in) to improve the prediction approach through a feedback loop.

Solutions provided by the embodiments of the present disclosure can include leveraging internal and a partner data ecosystem (e.g., between shippers/retails, 3PL providers and warehouse providers) to predict the likelihood of product returns and use the data/insights to drive decisions around warehouse product placements and warehouse inventory levels. Internal & partner data ecosystem (between shippers/retails, 3PL providers) can also be leveraged to predict the likelihood of a product reorder once a product is returned. The data can also be used to predict the set of possible locations from where product reorder will happen. The data can also be used to determine the best warehouse location to store the shipment considering factors such as reorder likelihood and reorder duration. The data can also be used to determine the duration for which the product should be stored at the warehouse. The data can also be used to determine the subsequent action on the shipment in warehouse once the product has passed it storage duration date within the warehouse. The actions can range from returning the product back to shipper, moving the product to a different warehouse, or continue storing the product for an extended duration within the same warehouse. Methods and systems according to the present disclosure can also leverage data to determine likelihood of returns to determine product differences for higher moving product reorders versus lower moving product reorders allowing further decisions on managing warehouse inventory levels. Feedback loops can be considered for recommendations and improve the decision-making process for subsequent iterations continuously.

A method and system according to the present disclosure can include optimizing reverse logistics by intelligent product placement within a distribution network by gathering data from various sources in order to leverage advanced analytics and machine learning to build key insights that can be leveraged during returns process to help maximize benefits for all parties. More specifically, a method and system can include leveraging internal & partner data ecosystem (between shippers/retails, third party logistics company (3PL) providers and warehouse providers) to predict the likelihood of product returns and use those insights to drive decisions around warehouse product placements and warehouse inventory levels. The method and system can further include predicting the likelihood of product reorder once a product is returned and further predict the likelihood of product reorder once a product is returned. The method and system can include determining the best warehouse location to store the shipment considering factors such as reorder likelihood and reorder duration. The method and system can include determining the duration for which the product should be stored at the warehouse and further determining the subsequent action on the shipment in warehouse once the product has passed it storage duration date within the warehouse. An action can range from returning the product back to a shipper, moving the product to a different warehouse, or continue storing the product for an extended duration within the same warehouse. The method and system can include leveraging the likelihood of returns to determine product differences for higher moving product reorders versus lower moving product reorders allowing further decisions on managing warehouse inventory levels, and considering feedback loop for each of the recommendation and improve the decision-making process for subsequent iterations continuously. Methods and systems according to the present disclosure can predict the likelihood of a product reorder once a product is returned and further predict the likelihood of a product reorder once a product is returned. The methods and systems can include determining the best warehouse location to store the shipment considering factors such as reorder likelihood and reorder duration.

Referring to embodiments and figures of the present disclosure, embodiments and figures may have the same or similar components as other embodiments. Such figures and descriptions can illustrate and explain further examples and embodiments according to the present disclosure.

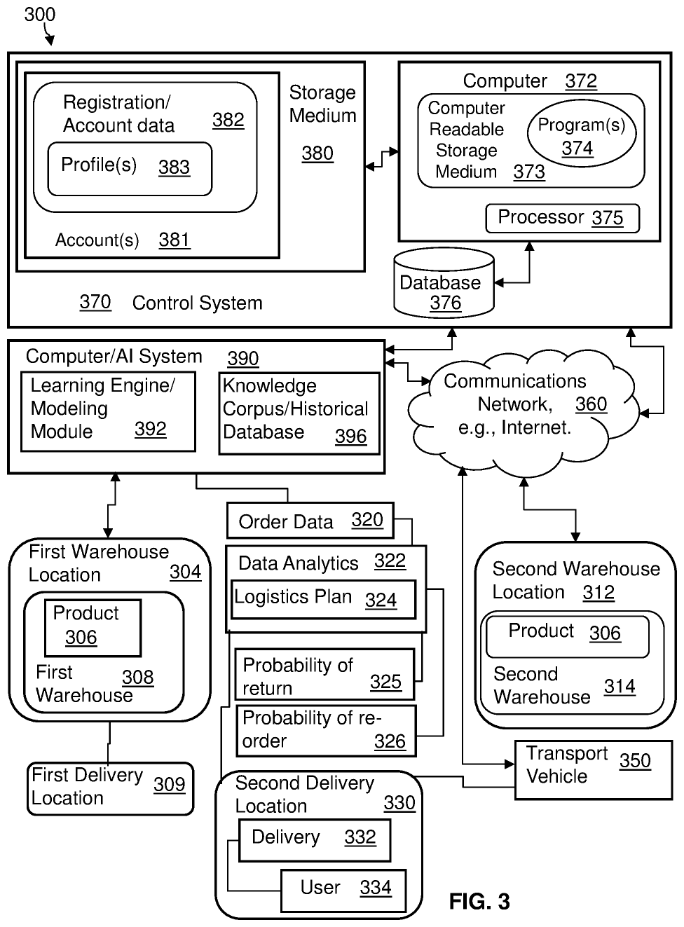

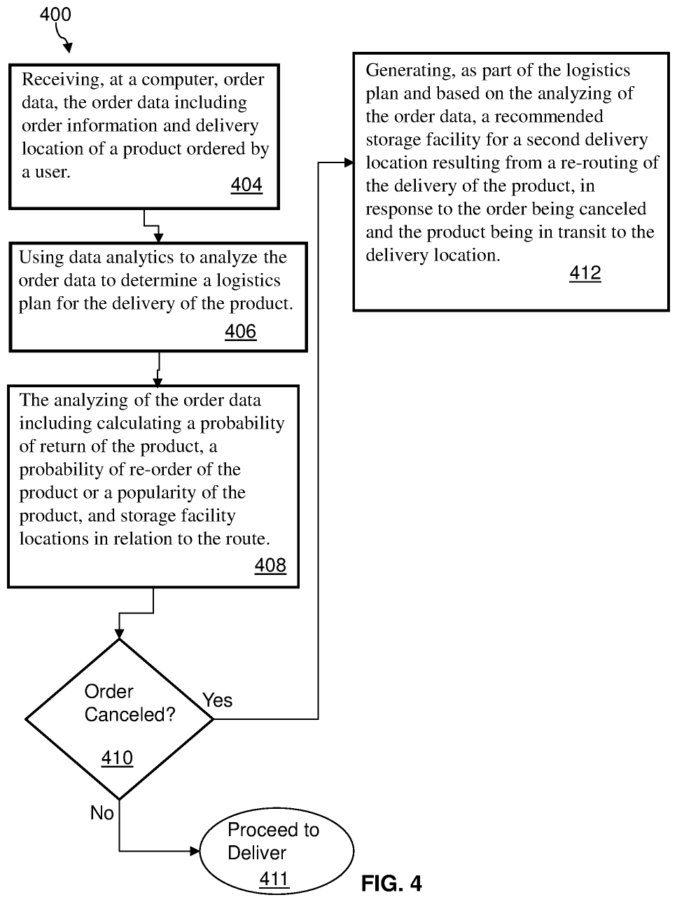

Referring to FIGS. 3 and 4, a system 300 and method 400 according to embodiments of the present disclosure includes a computer-implemented method 200 for delivering a product within a product distribution network. The computer-implemented method includes a series of operational blocks for implementing an embodiment according to the present disclosure which can include systems shown in the figures. The operational blocks of the methods and systems according to the present disclosure can include techniques, mechanism, modules, and the like for implementing the functions of the operations in accordance with the present disclosure.

Again referring to FIGS. 3 and 4, the method 400 includes receiving, at a computer 390, order data 320, the order data includes order information and a delivery location, embodied as a first delivery location 309, of a product 306 ordered by a user 334, as in block 404. The order data can further include an order history of the user including order returns or cancelations, and the order data can further include a start location for the product, and a route for delivery of the product to the delivery location 309.

The method 400 further includes using data analytics 322 to analyze the order data to determine a logistics plan 324 for the delivery of the product, as in block 406. The method includes the analyzing of the order data including calculating a probability of return 325 of the product, a probability of re-order 326 of the product or a popularity of the product, and storage facility locations in relation to the route, as in block 408.

The method includes generating, as part of the logistics plan and based on the analyzing of the order data, a recommended storage facility, embodied as a second warehouse location 312, for a second delivery location 330 resulting from a re-routing of the delivery of the product, in response to the order being canceled and the product being in transit to the delivery location. For example, the product can be stored in a first warehouse 308 at the first warehouse location 304. A transport vehicle 350 can move the product to a second warehouse 314 at a second warehouse location 312, in response to an order being canceled, at block 410 and the product being in transit to a delivery location. The product can then be delivered 332 by the transport vehicle 350 to the second delivery location 330 for the user 334 in response to a reorder of the product by the user while the product is stored at the second warehouse 314. When the order is not canceled at block 410, the product can proceed to deliver 411 the package.

The method can further include the recommended storage facility as a warehouse in a vicinity of the product when the product is in transit to the delivery location or a destination. In one example, the recommended storage facility can be an originating warehouse for the product. In another example, the user can be a consumer or an end user, or in another example, the user can be a distributor for the product.

The method can include calculating a time duration for the product to remain at the recommended storage facility. In another example, the method can further include calculating a time duration for the product to remain at the recommended storage facility, and initiating shipping of the product to another storage facility when the duration of time has lapsed. In another example, the method can include calculating when the product has a higher likelihood of reorder when the product is moved to another storage facility or warehouse location. The method can include, wherein the probability of the re-order of the product includes, determining a popularity of the product among customers or consumers.

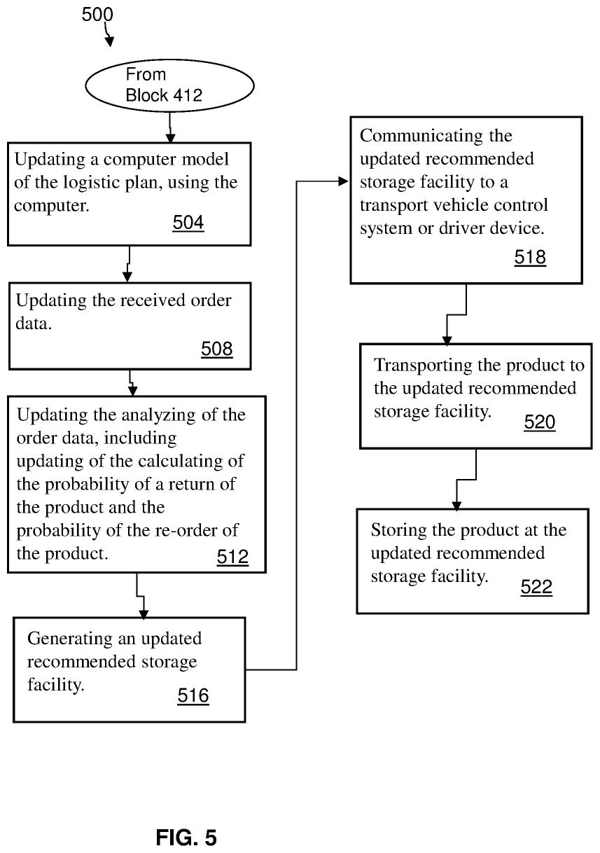

Referring to FIG. 5, in another embodiment according to the present disclosure, the method 500 continues from block 412 of the method 400 shown in FIG. 4, and can include updating a computer model of the logistic plan, using the computer, as in block 504. The updated model includes updating the received order data, as in block 508. The method includes updating the analyzing of the order data, including updating of the calculating of the probability of a return of the product and the probability of the re-order of the product, as in block 512. The method includes generating an updated recommended storage facility, as in block 516. In one example, the method can include communicating the updated recommended storage facility to transport vehicle control system, such as a dispatch, and /or a driver device to alert and instruct the driver to transport the product or package to the updated recommended storage facility, as in block 518. The method includes transporting the product to the updated recommended storage facility, as in block 520. Further the method includes storing the product, once transported, at the updated recommended storage facility, as in block 522.

The method further includes iteratively generating the model to produce updated models.

The method can further include communicating, using the computer, the recommended storage facility to a control system. In other examples, the communication can include one or more of a control system, a user device, a delivery person device, or a remote system used in the logistics plan for managing transit. The method can include communicating the re-routing of the delivery of the product to the control system; and physically transporting the product to the recommended storage facility using the control system. The routing of the product can include a transport vehicle.

In one example, a computer generated model can be generated using a learning engine or modeling module 392 of a computer system 390 which can be all or in part of an Artificial Intelligence (AI) system which communicates with the computer 372 and/or a control system 370. Such a computer system 390 can include or communicate with a knowledge corpus or historical database 396. In one example, the method and operations can include determining when a model is acceptable, and the method can proceed with operations. In another example, an acceptable model can include a model meeting specified parameters. In another example, an acceptable model can be a model which has undergone several iterations. When the model is not acceptable, a method can return to a previous operation represented by a block in a flowchart.

Further referring to FIG. 3, one or more computers (not shown) can be included at the warehouse locations, as a user device, in a vehicle, as mobile devices, etc. The computer 390 can be remote from a device and can electronically communicate, in all or in part, with the computer 372 as part of the control system 370. The control system can include the computer 372 having a computer readable storage medium 373 which can store one or more programs 374, and a processor 375 for executing program instructions. The control system can also include a storage medium which can include registration and/or account data 382 and profiles 383 of users or entities (such entities can include robotic entities) as part of user accounts 381. User accounts 381 can be stored on a storage medium 380 which is part of the control system 370. The user accounts 381 can include registrations and account data 382 and user profiles 383. The control system can also include a computer 372 having a computer readable storage medium 373 which can store programs or code embedded on the storage medium. The program code can be executed by a processor 375. The computer 372 can communicate with a database 376. The control system 370 can also include a database 376 for storing all or part of such data as described above, and other data.

The control system can also communicate with a computer system 190 which can include a learning engine/module 392 and a knowledge corpus or database 396. The computer system 390 can also communicate with a computer of a device and can be remote from the user device. In another example, the computer system 390 can be all or part of the control system, or all or part of a device. The depiction of the computer system 390 as well as the other components of the system 300 are shown as one example according to the present disclosure.

In one example, a new or different AI (Artificial Intelligence) ecosystem, or technology/communication or IT (Information Technology) ecosystem can include a local communications network which can communicate with the communications network 360. The system 300 can include a learning engine/module 392, which can be at least part of the control system or communicating with the control system, for generating a model or learning model. In one example, the learning model can model workflow in a new AI or IT ecosystem for machine/devices in the new ecosystem.

In another example, a computer can be part of a device. The computer can include a processor and a computer readable storage medium where an application can be stored which can in one example, embody all or part of the method of the present disclosure. The application can include all or part of instructions to implement the method of the present disclosure, embodied in code and stored on a computer readable storage medium. The device can include a display. The device can operate, in all or in part, in conjunction with a remote server by way of a communications network, for example, the Internet.

The method can include an analysis generating a model based on received data. A model can also be generated by an AI system such as an output at least in part of an AI system analysis using machine learning.

In one example, as part of the analysis of received data including data in the knowledge corpus and historical database 396, which can be populated by historical data gathered, for example, from sensors, robotic device, or other machines or devices, and authorized use of data by a user which can be populated by a user.

### OTHER EMBODIMENTS AND EXAMPLES

Referring to FIG. 1, a device can also be referred to as a user device or an administrator's device, includes a computer having a processor and a storage medium where an application, can be stored. The application can embody the features of the method of the present disclosure as instructions. The user can connect to a learning engine using the device. An application can embody the method of the present disclosure and can be stored on a computer readable storage medium 372. The processor 375 can be used for executing the application/software 374. The computer 372 can communicate with a communications network 360, e.g., the Internet.

It is understood that a user device can be representative of similar devices which can be for other users, as representative of such devices, which can include, mobile devices, smart devices, laptop computers etc.

In one example, the system 300 of the present disclosure can include a control system 370 communicating with a user device via a communications network 360. The control system can incorporate all or part of an application or software for implementing the method of the present disclosure. The control system can include a computer readable storage medium 373 where account data and/or registration data 382 can be stored. User profiles 383 can be part of the account data and stored on the storage medium 380. The control system can include a computer 372 having computer readable storage medium 373 and software programs 374 stored therein. A processor 375 can be used to execute or implement the instructions of the software program. The control system can also include a database 376.

In another example and embodiment, profiles can be saved for entities such as users, participants, operators, human operators, or robotic devices. Such profiles can supply data regarding the user and history of deliveries for analysis. In one example, a user can register or create an account using the control system which can include one or more profiles as part of registration and/or account data. The registration can include profiles for each user having personalized data. For example, users can register using a website via their computer and GUI (Graphical User Interface) interface. The registration or account data 182 can include profiles for an account for each user. Such accounts can be stored on the control system, which can also use the database for data storage. A user and a related account can refer to, for example, a person, or an entity, or a corporate entity, or a corporate department, or another machine such as an entity for automation such as a system using, in all or in part, artificial intelligence.

Referring to the figures, in embodiments according to the present disclosure, similar components may have the same or different reference numerals, and are depicted as examples, the systems can include or operate in concert with a computer implemented method as disclosed herein.

### MORE EXAMPLES AND EMBODIMENTS

Operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

### STILL FURTHER EMBODIMENTS AND EXAMPLES

It is understood that the features shown in some of the FIGS., for example block diagrams, are functional representations of features of the present disclosure. Such features are shown in embodiments of the systems and methods of the present disclosure for illustrative purposes to clarify the functionality of features of the present disclosure.

The methods and systems of the present disclosure can include a series of operation blocks for implementing one or more embodiments according to the present disclosure. In some examples, operational blocks of one or more FIGS. may be similar to operational blocks shown in another figure. A method shown in one FIG. may be another example embodiment which can include aspects/operations shown in another FIG. and discussed previously.

### ADDITIONAL EXAMPLES AND EMBODIMENTS

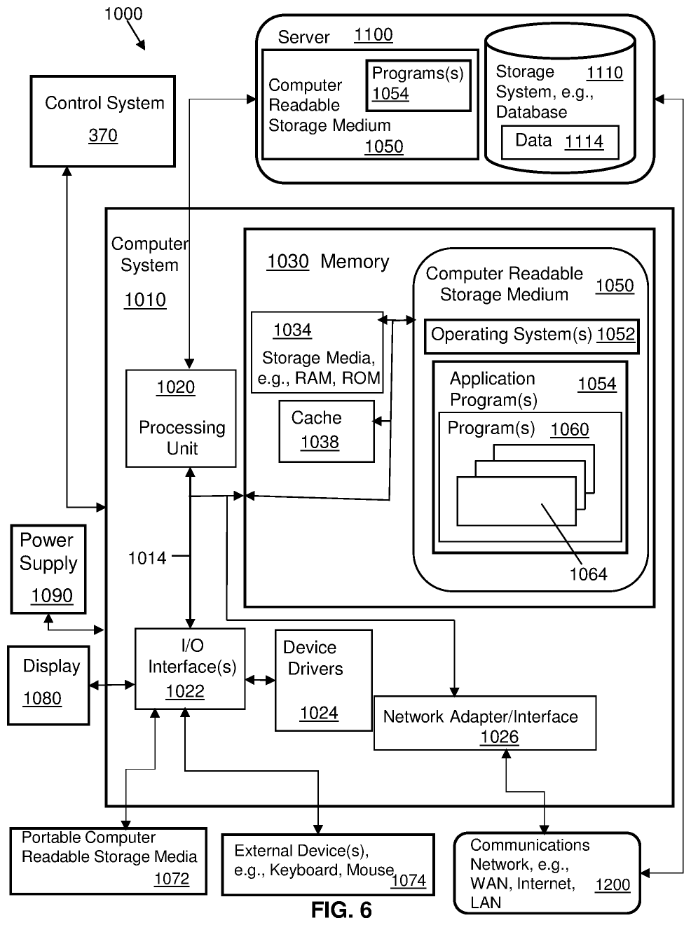

In the embodiment of the present disclosure shown in FIGS. 1 and 2, a computer can be part of a remote computer or a remote server, for example, remote server 1100 (FIG. 6). In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Thereby, a method according to an embodiment of the present disclosure, can be incorporated in one or more computer programs or an application stored on an electronic storage medium, and executable by the processor, as part of the computer on mobile device. For example, a mobile device can communicate with the control system 370, and in another example, a device such as a video feed device can communicate directly with the control system 370. Other users (not shown) may have similar mobile devices which communicate with the control system similarly. The application can be stored, all or in part, on a computer or a computer in a mobile device and at a control system communicating with the mobile device, for example, using the communications network 360, such as the Internet. It is envisioned that the application can access all or part of program instructions to implement the method of the present disclosure. The program or application can communicate with a remote computer system via a communications network 160 (e.g., the Internet) and access data, and cooperate with program(s) stored on the remote computer system. Such interactions and mechanisms are described in further detail herein and referred to regarding components of a computer system, such as computer readable storage media, which are shown in one embodiment and described in more detail in regards thereto referring to one or more computer systems 1010.

In another example, the control system can have a front-end computer belonging to one or more users, and a back-end computer embodied as the control system. Other computer systems can include similar components and features as shown in the computer system 1000.

The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

It is envisioned that the control system can not only store the profile of users, but in one embodiment, can interact with a website for viewing on a display of a device such as a mobile device, or in another example the Internet, and receive user input related to the method and system of the present disclosure. It is understood that FIG. 1 depicts one or more profiles 183, however, the method can include multiple profiles, users, registrations, etc. It is envisioned that a plurality of users or a group of users can register and provide profiles using the control system for use according to the method and system of the present disclosure.

Account data, for instance, including profile data related to a user, and any data, personal or otherwise, can be collected and stored, for example, in the control system. It is understood that such data collection is done with the knowledge and consent of a user, and stored to preserve privacy, which is discussed in more detail below. Such data can include personal data, and data regarding personal items.

In one example a user can register have an account with a user profile on a control system, which is discussed in more detail below. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### OTHER ADDITIONAL EMBODIMENTS AND EXAMPLES

In one example, Artificial Intelligence (AI) can be used, all or in part, for generating a model or a learning model as discussed herein in embodiments of the present disclosure. An Artificial Intelligence (AI) System can include machines, computer, and computer programs which are designed to be intelligent or mirror intelligence. Such systems can include computers executing algorithms. AI can include machine learning and deep learning. For example, deep learning can include neural networks. An AI system can be cloud based, that is, using a cloud-based computing environment having computing resources.

In another example, the control system 170 can be all or part of an Artificial Intelligence (AI) system. For example, the control system can be one or more components of an AI system

It is also understood that the method 100 according to an embodiment of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

### FURTHER DISCUSSION REGARDING EXAMPLES AND EMBODIMENTS

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants. It is also understood that machine and device are used interchangeable herein to refer to machine or devices in one or more AI (Artificial Intelligence) ecosystems or environments.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### FURTHER ADDITIONAL EXAMPLES AND EMBODIMENTS

Referring to FIG. 6, an embodiment of system or computer environment 1000, according to the present disclosure, includes a computer system 1010 shown in the form of a generic computing device. One or more methods according to the present disclosure, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 370, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in the figures can include all or part of the computer system 1010 and its components, and/or the one or more computers can communicate with all or part of the computer system 1010 and its components as a remote computer system, to achieve the computer functions described in the present disclosure.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/0) interfaces 1022. A power supply 1090 can also connect to the computer using an electrical power supply interface (not shown). Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### STILL FURTHER ADDITIONAL EXAMPLES AND EMBODIMENTS

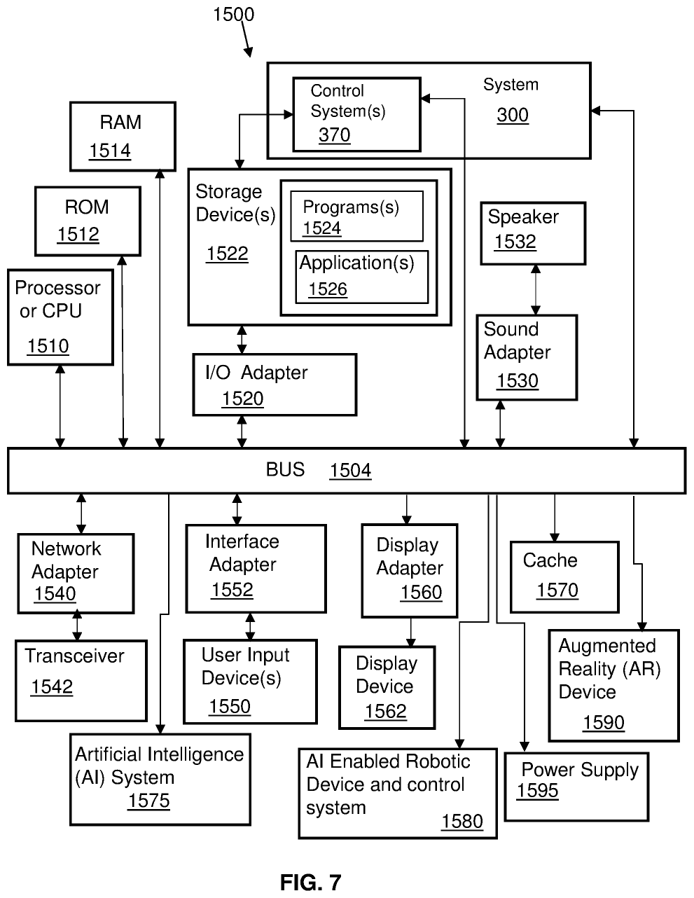

Referring to FIG. 7, an example system 1500 for use with the embodiments of the present disclosure is depicted. The system 1500 includes a plurality of components and elements connected via a system bus 1504. At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500. An AR device 1580 can also be operatively coupled to the bus 1504. An AI enabled robotic device and control system 1580 can also be operatively coupled to the bus 1504. Such a robot and control system 1580 can incorporate all or part of embodiments of the present disclosure and discussed hereinbefore. An artificial intelligence (AI) system 1575 or an AI ecosystem can also be operatively coupled to the bus 1504. A power supply 1595 can also be operatively connected to the bus 1504 for providing power to components and for functions according to the present disclosure. An augmented reality (AR) device 1590 can also be operatively connected to the bus 1504 for providing augmented reality output to a wearable augmented reality device, such as AR glasses or an AR headset.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. The storage device can include, for example, but not limited to, a hard drive or flash memory and be used to store one or more programs 1524 or applications 1526. The programs and applications are shown as generic components and are executable using the processor 1510. The program 1524 and/or application 1526 can include all of, or part of, programs or applications discussed in the present disclosure, as well vice versa, that is, the program 1524 and the application 1526 can be part of other applications or program discussed in the present disclosure.

The system 1500 can include the control system 370 which is part of the system 300 (described in further detail hereinbefore) and can communicate with the system bus independently or as part of the system 100, and thus can communicate with the other components of the system 1500 via the system bus. In one example, the storage device 1522, via the system bus, can communicate with the control system which has various functions as described in the present disclosure.

In one aspect, a speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

In another aspect, one or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

### OTHER ASPECTS AND EXAMPLES

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### ADDITIONAL ASPECTS AND EXAMPLES

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 11, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 11 are intended to be illustrative only and that computing nodes 2010 and cloud computing environment 2050 can communicate with any type of computerized device over any type of network and/or network addressable connection (e.g., using a web browser).

Referring now to FIG. 12, a set of functional abstraction layers provided by cloud computing environment 2050 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and optimizing logistics using computer analysis 2096, for example, for delivering a product within a product distribution network.

What is claimed is:

1. A computer-implemented method for optimizing logistics for delivering a product within a product distribution network, comprising:
receiving, at a computer, order data, the order data including order information and delivery location of a product ordered by a user, the order data further including an order history of the user including order returns or cancelations, the order data further including a start location for the product, and a route for delivery of the product to the delivery location;
using data analytics, analyzing the order data to determine a logistics plan for the delivery of the product;
the analyzing including calculating a probability of return of the product, a probability of re-order of the product, and storage facility locations in relation to the route; and
generating, as part of the logistics plan and based on the analyzing of the order data, a recommended storage facility for a second delivery location resulting from a re-routing of the delivery of the product, in response to the order being canceled and the product being in transit to the delivery location. and

2. The method of claim 1, wherein the recommended storage facility is a warehouse in a vicinity of the product when the product is in transit to the delivery location.

3. The method of claim 1, wherein the recommended storage facility is an originating warehouse for the product.

4. The method of claim 1, wherein the user is a consumer.

5. The method of claim 1, wherein the user is a distributor for the product.

6. The method of claim 1, calculating a time duration for the product to remain at the recommended storage facility.

7. The method of claim 1, further comprising:
calculating a time duration for the product to remain at the recommended storage facility;
initiating shipping of the product to another storage facility when the duration of time has lapsed.

8. The method of claim 1, further comprising:
calculating when the product has a higher likelihood of reorder when the product is moved to another storage facility.

9. The method of claim 1, wherein the probability of the re-order of the product includes determining a popularity of the product among customers.

10. The method of claim 1, further comprising:
updating a computer model of the logistic plan, using the computer; the updated model includes the following:
updating the received order data;
updating the analyzing of the order data, including updating of the calculating of the probability of a return of the product and the probability of the re-order of the product; and
generating an updated recommended storage facility.

11. The method of claim 10, further comprising:
iteratively generating the model to produce updated models.

12. The method of claim 1, further comprising:
communicating, using the computer, the recommended storage facility to a control system;
communicating the re-routing of the delivery of the product to the control system; and
physically transporting the product to the recommended storage facility using the control system.

13. The method of claim 12, wherein the routing of the product includes a transport vehicle.

14. A system for optimizing logistics for delivering a product within a product distribution network, which comprises:
a computer system comprising; a computer processor, a computer-readable storage medium, and program instructions stored on the computer-readable storage medium being executable by the processor, to cause the computer system to perform the following functions to:
receive, at a computer, order data, the order data including order information and delivery location of a product ordered by a user, the order data further including an order history of the user including order returns or cancelations, the order data further including a start location for the product, and a route for delivery of the product to the delivery location;
using data analytics, analyze the order data to determine a logistics plan for the delivery of the product;
the analyze including calculating a probability of return of the product, a probability of re-order of the product, and storage facility locations in relation to the route; and
generate, as part of the logistics plan and based on the analyzing of the order data, a recommended storage facility for a second delivery location resulting from a re-routing of the delivery of the product, in response to the order being canceled and the product being in transit to the delivery location.

15. The system of claim 14, wherein the recommended storage facility is a warehouse in a vicinity of the product when the product is in transit to the delivery location.

16. The system of claim 14, wherein the recommended storage facility is an originating warehouse for the product.

17. The system of claim 14, wherein the user is a consumer.

18. The system of claim 14, wherein the user is a distributor for the product.

19. The system of claim 14, further comprising:
calculating a time duration for the product to remain at the recommended storage facility.

20. A computer program product for optimizing logistics for delivering a product within a product distribution network, the computer program product comprising a computer readable storage medium having program instructions embodied therewith, the program instructions executable by a computer to cause the computer to perform functions, by the computer, comprising the functions to:
receive, at a computer, order data, the order data including order information and delivery location of a product ordered by a user, the order data further including an order history of the user including order returns or cancelations, the order data further including a start location for the product, and a route for delivery of the product to the delivery location;
using data analytics, analyze the order data to determine a logistics plan for the delivery of the product;
the analyze including calculating a probability of return of the product, a probability of re-order of the product, and storage facility locations in relation to the route; and
generate, as part of the logistics plan and based on the analyzing of the order data, a recommended storage facility for a second delivery location resulting from a re-routing of the delivery of the product, in response to the order being canceled and the product being in transit to the delivery location.
